(19) United States
(12) Patent Application Publication
(10) Pub. No.: US 2007/0176854 A1
(43) Pub. Date: Aug. 2, 2007

(54) IRREGULAR SCREEN FORMAT FOR LED AND OLED SYSTEMS

(75) Inventors: Matthew Ward, San Francisco, CA (US); Jeremy Hochman, Austin, TX (US); Nils Thorjussen, Austin, TX (US); Christopher Varrin, Austin, TX (US)

Correspondence Address: OSHA LIANG L.L.P., 1221 MCKINNEY STREET, SUITE 2800, HOUSTON, TX, 77010, US

(73) Assignee: Element Labs, Inc., Santa Clara, CA (US)

(21) Appl. No.: 11/625,095

(22) Filed: Jan. 19, 2007

Related U.S. Application Data
(60) Provisional application No. 60/761,788, filed on Jan. 25, 2006.

(51) Int. Cl. G09G 3/06

(52) U.S. Cl. 345/44

(57) ABSTRACT

A display panel including a plurality of pixels disposed on a surface of the display panel is disclosed. The plurality of pixels are configured to receive an electrical signal and power and are disposed in an irregular arrangement. Furthermore, a method for displaying an image is disclosed. The method includes providing a display panel having a plurality of pixels disposed on a surface of the display panel, wherein the plurality of pixels are configured to receive an electrical signal and power, and wherein the plurality of pixels are disposed in an irregular arrangement. The method further includes sending a data signal to the display panel, wherein the plurality of pixels are further configured to display the image based on the data signal.

### CROSS REFERENCE TO RELATED APPLICATIONS

This application claims benefit of U.S. Provisional Application Ser. No. 60/761,788 filed on Jan. 25, 2006, entitled “Modified Random Pixel Structure” in the name of Matthew Ward.

### BACKGROUND

1. Field

Embodiments of the present invention generally relate to display units.

2. Background Art

Display units for entertainment, architectural, and advertising purposes have commonly been constructed of numbers of light emitting elements, such as LEDs or incandescent lamps mounted onto flat panels. These light emitting elements may be selectively turned on and off to create patterns, graphics and video displays for both informational and aesthetic purposes. It is well known to construct these displays of tiles or large panels, each containing several light emitting elements, which may be assembled in position for an entertainment show or event, or as an architectural or advertising display. Examples of such systems are disclosed in U.S. Pat. Nos. 6,813,853, 6,704,989 and 6,314,669.

Increasingly, display units are being used on the exteriors of buildings for entertainment, architectural, or advertising purposes in a manner that does not fully integrate them into the style and physical envelope of the building. For example, Times Square in New York City and the Las Vegas Strip are two areas littered with such display units either contained within the curtain wall of glass buildings or grafted onto the outside of buildings with little regard for the buildings' architecture. This is exemplified by the multiple billboard-style displays located in these areas.

As this practice increases, it will be useful to incorporate the display units into the actual skin of the building. One way of doing that is to combine the cladding system (e.g., a stainless steel or aluminum cladding system) with a display unit. The display unit could be a standard matrix type with the LED clusters mounted in holes or mounted on the exterior. U.S. Pat. No. 6,237,918, issued to Tokimoto and incorporated herein by reference, discloses such a system, effectively integrating the electronic and structural components of a display unit into the outer structure of a building. In this system, the LED beams forming a matrix of pixels are incorporated into a void in the glass wall of the building. However, this type of system has several limitations preventing full architectural usefulness of the display units. Specifically, such a system is difficult to maintain and the matrix of pixels imposes a grid pattern. Typically, all display units having a regular arrangement of pixels impose some sort of grid pattern that results in unwanted effects, such as moiré patterns.

Prior art display units do not offer solutions that meet the needs of designers and architects. The regular, repeating patterns inherent in such display units are very apparent to the viewer, and thus interfere with and restrict the design scope of the architect. A rigid, repeating pixel dot pattern enforces its own linear array pattern superimposed on the building design and architecture. This visual interference and distraction is a problem both when the display unit is in use and when it is turned off. Other prior art solutions offer a fully random pattern that may assist with the visual interference, but also may cause problems with poor image quality when the display is operational, and further may produce objectionable clumping of the pixels.

Referring to FIG. 1, two examples of prior art panels 100, 105 are shown. Both panels are configured in a matrix form. The lower resolution panel 100 is composed of large tiles 101. The higher resolution panel 105 is composed of clusters of light emitting diodes 106. Both panels may suffer moiré problems with video cameras. A moiré pattern is an interference pattern created, for example, when two grids are overlaid at an angle, or when they have slightly different mesh sizes. Basically, any regular arrangement of lighting elements in a display unit may cause significant and unwanted moiré patterns.

Furthermore, both panels also have a very recognizable grid pattern that makes it more difficult for these screens to flow across irregular surfaces. Software now allows architects to create flowing buildings with no obvious corners or joints, and the elimination of obvious patterns in display units will become more important as interest in asymmetrical structures grows.

Thus, there is a growing need for display units without a regular arrangement of lighting elements. Such display units would be useful as systems that could be incorporated into any structure having regular or irregular surfaces, as well as free-standing display systems.

### SUMMARY

In one aspect, the invention relates to a display panel including a plurality of pixels disposed on a surface of the display panel. The plurality of pixels are configured to receive an electrical signal and power, and the plurality of pixels are disposed in an irregular arrangement.

In another aspect, the invention relates to a display panel including a plurality of pixels disposed on a surface of the display panel, wherein the plurality of pixels are disposed in a regular arrangement and configured to receive an electrical signal and power. The display panel further includes at least one light guide mounted over the plurality of pixels, wherein the light guide is configured to direct light emitted from the plurality of pixels into an irregular arrangement.

In another aspect, the invention relates to a display system including a plurality of display panels. Each of the plurality of display panels includes a plurality of pixels disposed on a surface of the display panel, wherein the plurality of pixels are configured to receive an electrical signal and power and disposed in an irregular arrangement. Further, each of the plurality of display panels is mounted proximate to at least one other display panel.

In another aspect, the invention relates to a method for displaying an image, including providing a display panel including a plurality of pixels disposed on a surface of the display panel, wherein the plurality of pixels are configured to receive an electrical signal and power, and wherein the plurality of pixels are disposed in an irregular arrangement. The method further includes sending a data signal to the display panel, wherein the plurality of pixels are further configured to display the image based on the data signal.

Other aspects of the invention will be apparent from the following description and the appended claims.

### BRIEF DESCRIPTION OF DRAWINGS

FIG. 1 shows two prior art panels.

FIG. 2 shows an irregular arrangement of shapes.

FIG. 3A shows a display panel in accordance with one or more embodiments of the present invention.

FIG. 3B shows an enlarged area of FIG. 3A in accordance with one or more embodiments of the present invention.

FIG. 4A shows a display panel having curved ribs in accordance with one or more embodiments of the present invention.

FIG. 4B shows an enlarged area of FIG. 4A in accordance with one or more embodiments of the present invention.

FIG. 5 shows a side view of the display panel of FIG. 3A in accordance with one or more embodiments of the present invention.

FIG. 6 shows a side view of a display panel including a light guide in accordance with one or more embodiments of the present invention.

FIG. 7 shows a display panel having a light guide and side-facing ribs in accordance with one or more embodiments of the present invention.

FIG. 8 shows low resolution portions in accordance with one or more embodiments of the present invention.

FIG. 9 shows a pixel composed of a plurality of sub-pixels in accordance with one or more embodiments of the present invention.

FIG. 10 shows a display panel system in accordance with one or more embodiments of the present invention.

FIG. 11 shows a display system including a plurality of display panels in accordance with one or more embodiments of the present invention.

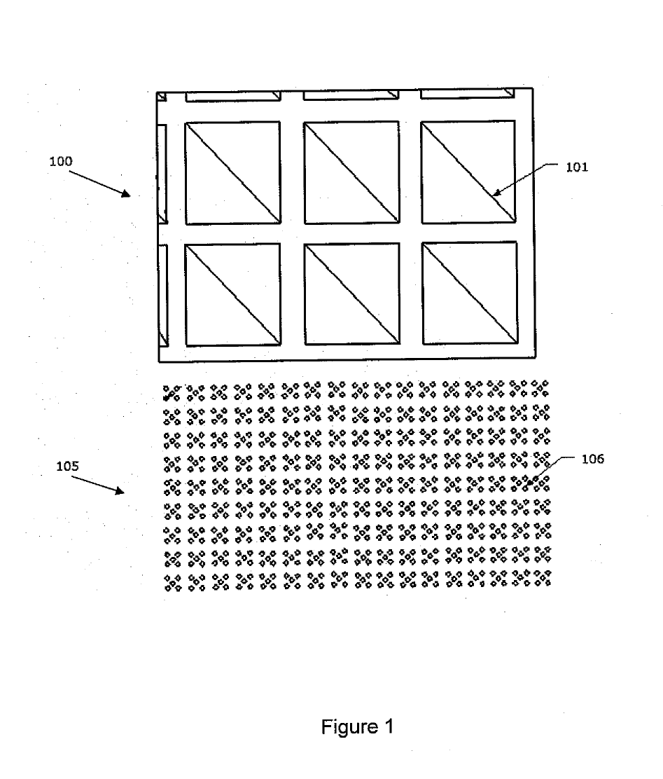

### DETAILED DESCRIPTION

Specific embodiments of the present invention will now be described in detail with reference to the accompanying figures. Like elements in the various figures may be denoted by like reference numerals for consistency.

In the following detailed description of embodiments of the present invention, numerous specific details are set forth in order to provide a more thorough understanding of the invention. However, it will be apparent to one of ordinary skill in the art that the present invention may be practiced without these specific details. In other instances, well-known features have not been described in detail to avoid unnecessarily complicating the description.

In general, embodiments of the present invention relate to systems and methods for providing a display unit (i.e., display systems and panels) having an irregular arrangement of lighting elements, or pixels. Specifically, a display system may include one or more display panels having an irregular arrangement of pixels in which the display system is configured to display an image. An irregular arrangement of pixels is significantly less apparent to a viewer. Furthermore, if the display system is to be mounted to a building or structure, an irregular arrangement of pixels may not interfere with the design of the building or structure. Thus, such a display system may provide effective imagery during use, and further minimizes the visual interference of the display system when in operation and when turned off.

As discussed above, display units typically have pixels arranged in a regular and repeating form, such as a matrix, which imposes recognizable patterns and moiré effects. As used herein, “irregular arrangement” refers to an arrangement of pixels in which there is no discernible pattern of the pixels to a viewer, and thus does not impose recognizable patterns or moiré effects. Those skilled in the art will appreciate that numerous approaches exist, or will be developed in the future, that may be used to generate an irregular arrangement of pixels. However, the present invention is not intended to be limited by the generation of irregular arrangements of the pixels. For example, one or more embodiments of the present invention may utilize dot patterns based on the sequential generation of pseudo-random numbers to specify an irregular arrangement of pixels. However, a pseudo-random arrangement is not ideal, as such arrangements tend to have unevenness peculiar to pseudo-random numbers which may lead to the clumping of pixels.

Alternatively, an irregular arrangement of pixels may be based on a modified random sequence. A method of using a modified random sequence to generate a dot pattern is disclosed by T. Ide et al. (“Ide”) in “Moiré-Free Collimating Light Guide with Low-Discrepancy Dot Patterns,” which is hereby incorporated by reference in its entirety. Ide describes using a low-discrepancy sequence (LDS) to generate a dot pattern. Because the dots will represent individual pixels, dot overlap is undesirable, and thus Ide employs a theory from molecular dynamics whereby dots interact based on repulsive force. The result is the generation of appropriate dot patterns without abnormal clustering by an approach called dynamical LDS (DLDS). The DLDS approach is one example of how a modified random arrangement may be generated.

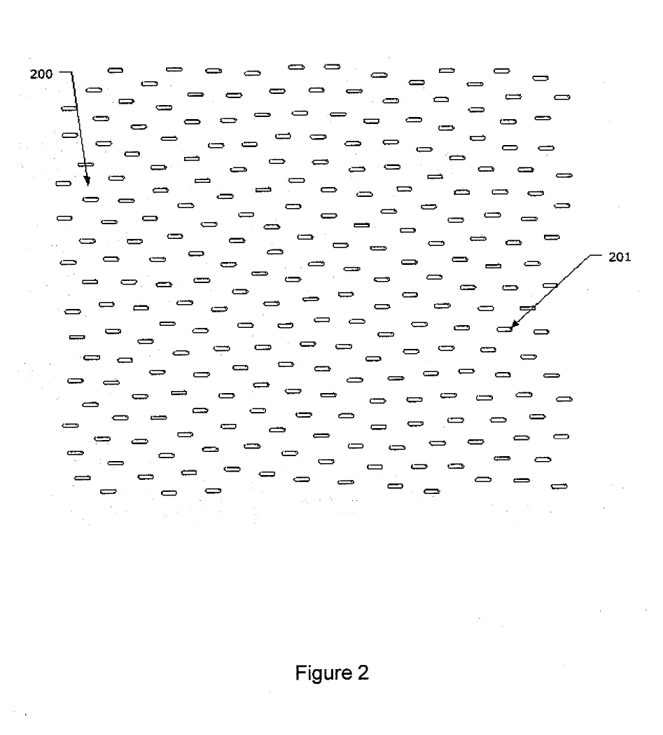

FIG. 2 shows an irregular arrangement 200 of shapes 201 based on the DLDS approach. The irregular arrangement 200 is one example of an arrangement based on a modified random sequence. As shown in FIG. 2, the use of a modified random sequence to generate an irregular arrangement eliminates both clustering and overly large spacing between shapes 201, which may occur with a truly random pattern. Furthermore, the irregular arrangement 200 still retains the benefits of a non-matrix layout, such as the lack of a discernible pattern and moiré effects. Thus, in one or more embodiments of the invention, the irregular arrangement 200 may be used as a basis for an irregular arrangement of pixels in a display unit. Additionally, given the benefit of this disclosure, those skilled in the art will appreciate that any irregular arrangement may be used as the basis for an irregular arrangement of pixels in a display unit. Such irregular arrangements may be generated by, for example, a DLDS approach, other approaches using modified random sequences, pseudo-random sequences, or truly random sequences, or any other approach known in the art.

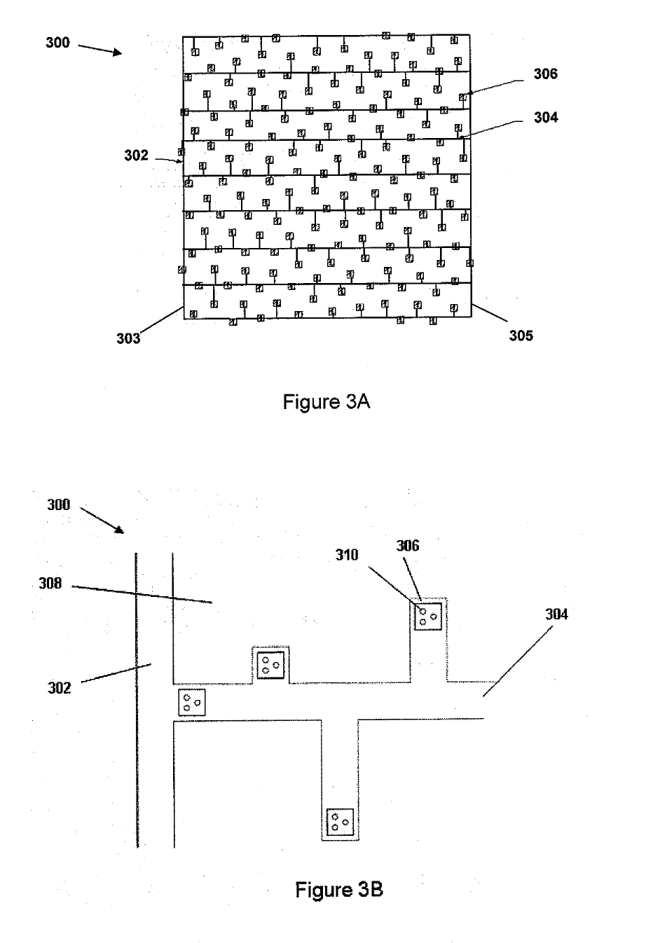

FIG. 3A shows a display panel 300 in accordance with one or more embodiments of the present invention. The display panel 300 includes a frame 302 having a plurality of ribs 304 connected thereto. The display panel 300 further includes a plurality of pixels 306, in which each of the pixels 306 is mounted on a surface of the display panel 300. Furthermore, the plurality of pixels 306 are mounted in an irregular arrangement. Specifically, the irregular arrangement shown in FIG. 3A is based on a modified random sequence as previously discussed with respect to FIG. 2. However, those skilled in the art will appreciate that the pixels 306 may be mounted according to any irregular arrangement.

In embodiments of the present invention, the interior portions of the display panel not including structural elements may or may not be solid. For example, in one embodiment, the display panel 300 is composed of a single continuous surface, such as a printed circuit board (PCB), wherein the entire interior surface of the display panel 300 is solid. In such an embodiment, the frame includes the entire continuous surface on which the ribs 304, the pixels 306, and any necessary electronics are mounted. The ribs 304 may simply be electrical connections (e.g., traces on the PCB) electrically connecting the pixels 306 to power and data signals. Thus, the ribs may not structurally support the pixels on the display panel.

In another embodiment, however, portions of the interior of the display panel 300 are not solid. Rather, these interior portions contain no surface, and thus are transparent. FIG. 3B shows an enlarged area of FIG. 3A in accordance with one or more embodiments of the present invention. In this embodiment, the frame 302 composes the outer periphery of the display panel 300 and the ribs 304 connect to the frame 302 and extend into the interior of the display panel 300. The ribs 304 include a surface (e.g., a PCB) on which the pixels 306, electrical connections, and any necessary electronics are mounted. Thus, in this embodiment, the ribs 304 support the pixels 306 and any other structural elements that may be mounted on the interior of the display panel 300. The remaining interior portions, indicated at 308 in FIG. 3B, are transparent.

Each of the plurality of pixels 306 may include one or more sub-pixels or lighting elements 310, as shown in FIG. 3B. Such lighting elements 310 may include, for example, light emitting diodes (LEDs), organic LEDs (OLEDs), polymer LEDs (PLEDs), incandescent lamps, or any other lighting elements known in the art. In one or more embodiments, one or more pixels 306 may each include a plurality of LEDs such that light of a desired color may be emitted from each pixel 306. For example, a pixel 306 may include at least one red LED, one green LED, and one blue LED such that the intensity of each LED may be varied to produce a desired color, as is well known in the art. Also, the pixels 306 may be of any size and shape (e.g., square, circular, etc.), and the size and shape of the pixels 306 need not be uniform throughout the display panel 300. Additionally, the pixels 306 are configured to receive an electrical signal (e.g., a data signal, control signal, etc.). Each pixel 306 may also include a driver circuit that varies the intensities of the lighting elements 310 within the pixel 306.

Referring back to FIG. 3A, although the display panel 300 is shown as square in shape, those skilled in the art will appreciate that the display panel 300 may be of any shape (e.g., rectangular, oval, etc.). Furthermore, the frame 302 may or may not enclose the interior of the display panel 300. For example, the frame 302 is shown in FIG. 3 having both a left frame member 303 and a right frame member 305, with the ribs 304 disposed therebetween. However, in one embodiment, the frame may only include the left frame member 303, and thus the ribs 304 may connect to and extend away from the left frame member 303 without connecting to another frame member at the opposite end of the ribs 304. Also, the ribs 304 may be connected in a regular arrangement (i.e., equal vertical spacing between the ribs 304) without affecting the irregular arrangement of the pixels 306.

Additionally, the display panel 300 is not required to be planar, as shown in FIG. 3. In one or more embodiments of the invention, the frame 302, the ribs 304, and the pixels 306 may be constructed in different planes. Alternatively, the surface of the display panel 300 may take on any irregular (i.e., non-planar) shape. For example, the display panel 300 could be constructed to have a curved surface. As previously discussed, an irregular arrangement of pixels is better suited to conform to irregular surfaces than are regular arrangements of pixels. Thus, the display panel 300 may be constructed to follow the shape of any building or architectural structure.

Furthermore, the surface of the display panel 300 may be constructed to be flexible. For example, the frame 302, the ribs 304, the electrical connections, and/or any other structural elements of the display panel 300 may be constructed from flexible materials, such as a film or bendable rods. Alternatively, parts of the display panel 300 may be constructed using pins, hinges, or other articulating members such that the display panel 300 is flexible. Such a flexible display panel may provide several advantages, such as conforming to irregular surfaces, or conforming to multiple uses throughout the lifetime of the display panel 300.

Even further, the display panel 300 may be constructed from one or more surfaces and/or materials. For example, the display panel may be constructed from a single PCB, wherein the PCB may be cut to form the frame 302 and ribs 304. Alternatively, the frame 302 and each of the ribs 304 could be constructed from multiple PCBs. Even further, the frame 302 may be constructed of a sturdier material, such as aluminum or steel, and the ribs 304 connected thereto may be constructed from one or more PCBs.

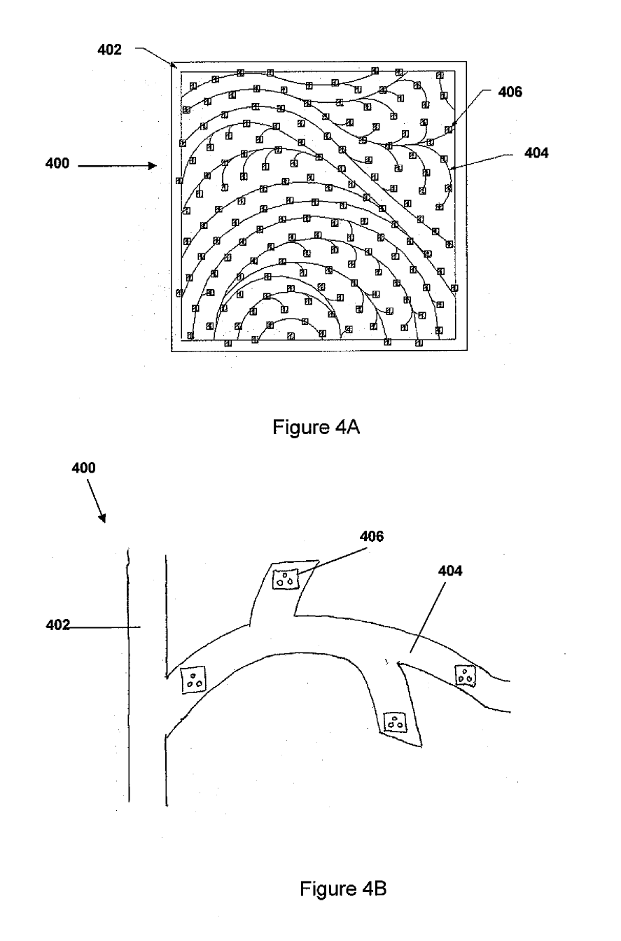

FIG. 4A shows a display panel 400 having curved ribs in accordance with one or more embodiments of the present invention. Additionally, FIG. 4B shows an enlarged area of FIG. 4A in accordance with one or more embodiments of the present invention. The display panel 400 includes a frame 402, a plurality of ribs 404 connected to the frame 402, and a plurality of pixels 406 mounted on each of the ribs 404. The display panel 400 is similar to the display panel 300 of FIGS. 3A and 3B. However, in this embodiment, the ribs 404 are configured to follow the irregular arrangement of the pixels 406. Such a configuration of the ribs 404 may make the arrangement of the pixels 406 even less obvious to a viewer. For example, when the display panel 400 is in use, the light emitting pixels 406 may effectively hide the ribs 404. However, when the display panel 400 is off, a regular arrangement of the ribs 404 may impose an unwanted pattern. Thus, the curved configuration of the ribs 404 may provide a more architecturally desirable display panel.

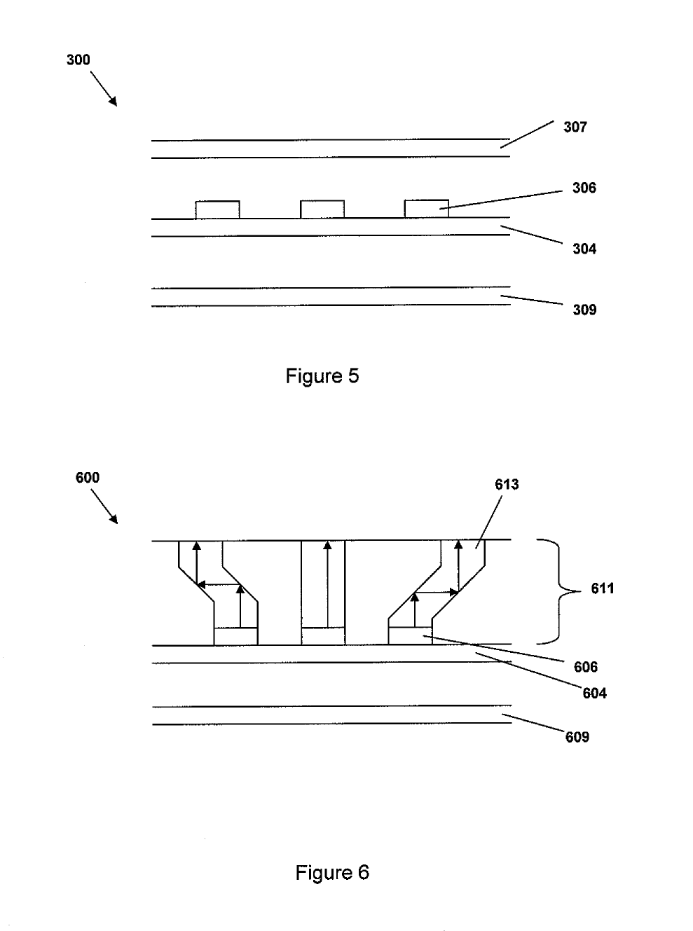

FIG. 5 shows a side view of the display panel 300 of FIG. 3 in accordance with one or more embodiments of the present invention. Specifically, FIG. 5 shows a side view of a rib 304 of the display panel 300 with a plurality of pixels 306 mounted thereto. However, in one or more embodiments, the side view could also be of the frame 302 of the display panel 300, wherein the pixels 306 would not be included. In this embodiment, the rib 304 is shown as a surface (e.g., a PCB) encased between a front cover 307 and a back cover 309. Additionally, the front and back covers 307, 309 may encase the entire display panel 300.

The front and back covers 307, 309 are configured to connect together to form a casing around the ribs 304 and/or the entire display panel 300. Such a casing may protect the display panel 300 from external elements. Furthermore, the casing may effectively hide the internal elements of the display panel 300 from a viewer. The front and back covers 307, 309 may be configured to connect together by any way known in the art, such as using snapping members, bolts, screws, pins, latches, or any other equivalent connecting members thereof. Even further, the front and back covers 307, 309 may be constructed from any material known in the art, such as plastics, metals, polymers, optical materials, flexible materials, or any equivalents thereof.

Furthermore, openings may be formed in the front cover 307 over the pixels 306 such that emitted light may project therethrough. Additionally, an optical material, such as a translucent material, may be disposed over the openings such that the display panel 300 may still be protected while emitting light. Any optical material may be used for this purpose, such as a translucent, transparent, diffusive, colored, refractive, and/or reflective material, or any other materials known in the art.

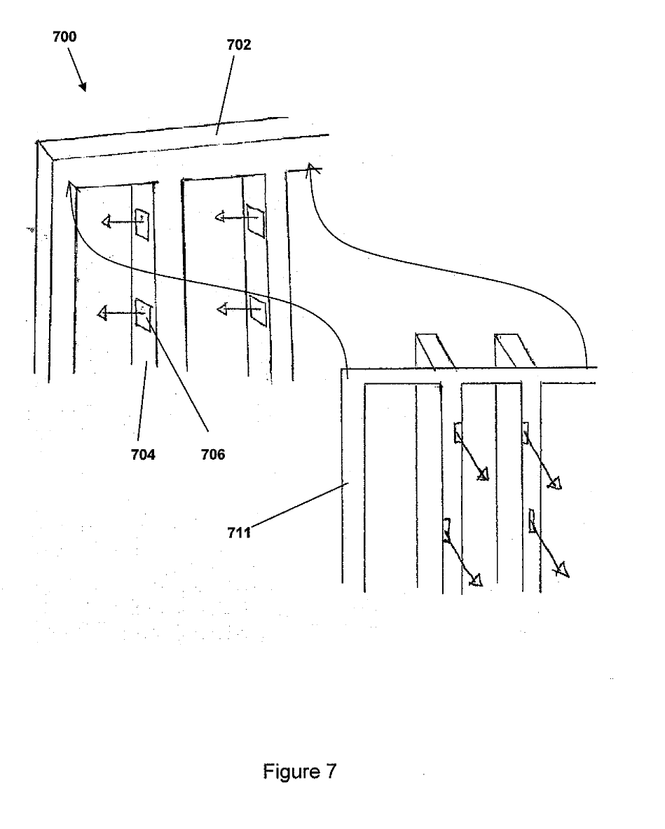

In one or more embodiments of the present invention, optical apparatus or methods may be used with a display panel to achieve the effect of having an irregular arrangement of pixels without actually arranging the pixels in an irregular fashion. For example, FIG. 6 shows a side view of a display panel 600 including a light guide 611 in accordance with one or more embodiments of the present invention. The display panel 600 is similar to the display panel 300 of FIG. 3, except that the display panel 600 has a regular arrangement of pixels 606 mounted thereon. However, the light guide 611 is configured to have pixels 606 project light in an irregular arrangement. For example, the pixels 606 may be in a matrix configuration (i.e., regular horizontal and vertical spacing between the pixels 606) and mounted on the surface of the ribs 604. The light guide 611 may be mounted over the ribs 604 and pixels 606, and may include a front cover similar to the front cover 307 in FIG. 5. Additionally, the display panel 600 may include a back cover 609 similar to the back cover 309 of FIG. 5 and may be configured to connect to the light guide 611 and/or front cover.

The light guide 611 is configured to direct a regular arrangement of light from pixels 606 into an irregular arrangement. In one or more embodiments, and as shown in FIG. 6, the light guide 611 includes a plurality of light pipes 613 extending from each pixel 606 toward an outer surface of the light guide 611. The light pipes 613 may also extend in any direction such that the light pipes 613 direct light emitted from the pixels 606 into an irregular arrangement. Thus, when viewed, the display panel 600 may seem to have an irregular arrangement of pixels. The light guide 611 and the light pipes 613 may be constructed of any materials known in the art to reliably direct and transmit light in a desired manner. Such materials may include translucent, transparent, diffusive, colored, refractive, and/or reflective materials. Additionally, the light pipes 613 may be hollow, or may be composed of a material that facilitates the transmission of light. Furthermore, the portions of the outer surface of the light guide 611 from which light projects may be open or covered, similarly discussed with respect to FIG. 5.

Moreover, the light guide 611 may be constructed as one part or multiple parts. For example, the light guide 611 may be constructed in one piece in the same shape as the frame and ribs 604 of the display panel 600, and mounted onto the frame and ribs 604. Alternatively, the light guide 611 may be constructed in the shape of the display panel 600 and with a solid interior, and thus mounted over the entire display panel 600. In another example, the light guide 611 may consist of multiple light guides 611 such that each light guide is mounted on a rib 604 of the display panel 600. Alternatively, each pixel 606 may include its own light guide 611, or light pipe 613, mounted thereon.

FIG. 7 shows a display panel 700 having a light guide 711 and side-facing ribs 704 in accordance with one or more embodiments of the present invention. The display panel 700 is similar to the display panel 600 having a light guide 611 as shown in FIG. 6. Specifically, the display panel 700 has a frame 702 connected to a plurality of ribs 704 in which a plurality of pixels 706 are mounted in a regular arrangement on each of the ribs 704. Furthermore, the light guide 711 is configured to direct light emitted from the pixels 706 into an irregular arrangement. However, in contrast to the embodiment of FIG. 6, the ribs 704 face sideways such that light emitted from the pixels 706 travels in a sideways direction as indicated by the arrows extending from the pixels 706. Furthermore, the light guide 711 is configured to direct light emitted from the pixels 706 in a forward direction as indicated by the arrows extending from the light guide 711. That is, light projected from the light guide 711 is orthogonal to light emitted from the side-facing pixels 706 such that the light is projected forward.

In FIG. 7, the light guide 711 is not shown mounted on the display panel 700 so that the pixels 706 may be shown. However, when the display panel 700 is completely constructed, the light guide 711 is mounted onto the display panel 700. Aside from directing light in a forward direction, the light guide 711 is otherwise similar to the light guide 611 shown in FIG. 6. Specifically, the light guide 711 may include a plurality of light pipes and may be constructed of any materials known in the art. Even further, the light guide 711 may be constructed as one part or multiple parts. For example, one or more light guides 711 may be mounted only over the ribs 704 and not connected to the frame 702. Alternatively, each pixel 706 may include its own light guide 711, or light pipe, mounted thereon.

By connecting the ribs 704 in a side-facing manner, the embodiment of FIG. 7 may provide some advantages. For example, the side profile of the ribs 704 may be thinner than the front face of the ribs 704, and thus the display panel 700 may have more empty, transparent space. Furthermore, the light guide 711 may only require one reflection to direct light emitted from the pixels 706 in both a forward direction and an irregular arrangement. In contrast, the light guide 611 of FIG. 6 may require two reflections to direct light into an irregular arrangement, as indicated by the arrows in FIG. 6.

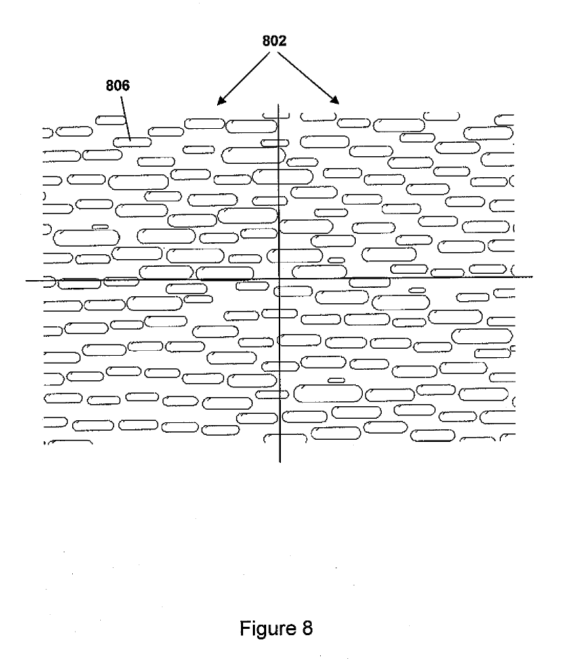

FIG. 8 shows low resolution portions 802 in accordance with one or more embodiments of the present invention. The low resolution portions 802 are designated as a collection of one or more pixels 806 in an irregular arrangement, similar to the pixels 306 in FIG. 3. Whereas previously discussed pixels, such as the pixels 306 in FIG. 3, may represent single points in an image in certain embodiments of the present invention. However, in this embodiment, the low resolution portions 802 may represent a single point in an image and the pixels 802 may be elements of the low resolution portion 802. Additionally, the pixels 806 may be constructed in various sizes (as shown), but each of the pixels 806 may be of any size or shape.

Designated collections of large and small pixels 806 form the larger low resolution portions 802, such that a plurality of low resolution portions 802 may produce a homogenized image. The use of varying sizes of pixels 806 to form a low resolution portion 802 is based on the fact that emitters, such as the pixels 806, appear as smaller point sources as they dim and larger sources as they brighten. Thus, a varied arrangement of large and small emitters may help to create a more homogenized image. In one or more embodiments, the smaller pixels 806 may be configured to handle high gain portions of an image, and the larger pixels 806 may be configured to handle the low gain portions of an image to create a more homogenized image.

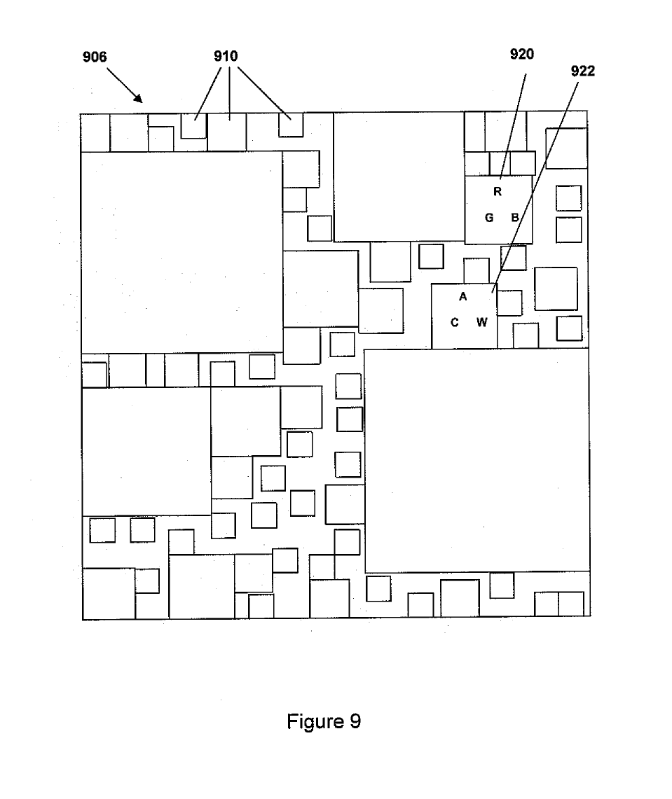

FIG. 9 shows a pixel 906 having a plurality of sub-pixels 910 in accordance with one or more embodiments of the present invention. The pixel 906 may be similar to the pixels 306 in FIG. 3, and thus, the plurality of the pixels 906 may be mounted to a surface in an irregular arrangement. In this embodiment, a sub-pixel is an element of a pixel. A sub-pixel may be a lighting element, such as an LED, OLED, PLED, incandescent lamp, or any other lighting elements known in the art. Additionally, a sub-pixel may be similar to a smaller pixel containing lighting elements, in which the sub-pixel may form a part of a larger pixel. As shown in FIG. 9, the sub-pixels 910 are disposed within the pixel 906 in an irregular arrangement. Furthermore, the sub-pixels 910 may each be formed in any size and shape.

In the embodiment of FIG. 9, the pixel 906 includes multiple sub-pixels 910 of various sizes so as to create a more homogenized image. More specifically, the sub-pixels 910 range in size from small to large, with the smaller sub-pixels 910 being significantly more numerous than the larger sub-pixels 910. As previously discussed with reference to FIG. 8, sub-pixels 910 generally may appear as smaller point sources as they dim and larger sources as they brighten. Therefore, in one embodiment, the larger sub-pixels 910 may be used to emit dimmer, lower-intensity light, and the smaller sub-pixels 910 may be used to emit brighter, higher-intensity light. This configuration may be used to create a more homogenized image. In addition, if a dimming effect is used with the pixel 906, then the smaller sub-pixels 910 may be dimmed more quickly than the larger sub-pixels 910. This may prevent a dimming pixel 910 from looking like many small point sources, and thus creating a more homogenized image.

Furthermore, each of the sub-pixels 910 may be configured to emit a single color of light, or may be configured to emit any color of light. Additionally, the color of light emitted by each sub-pixel 910, or the configuration of lighting elements of the sub-pixels 910, may or may not be uniform throughout the pixel 906, regardless of the sizes of the sub-pixels 910. For example, a first sub-pixel 920 may contain red, green, and blue lighting elements, but a second sub-pixel 922 of the same size may contain amber, cyan, and white lighting elements. Because viewers may perceive light in different ways, such variations in the colors of sub-pixels 910 may help create a more homogenized image.

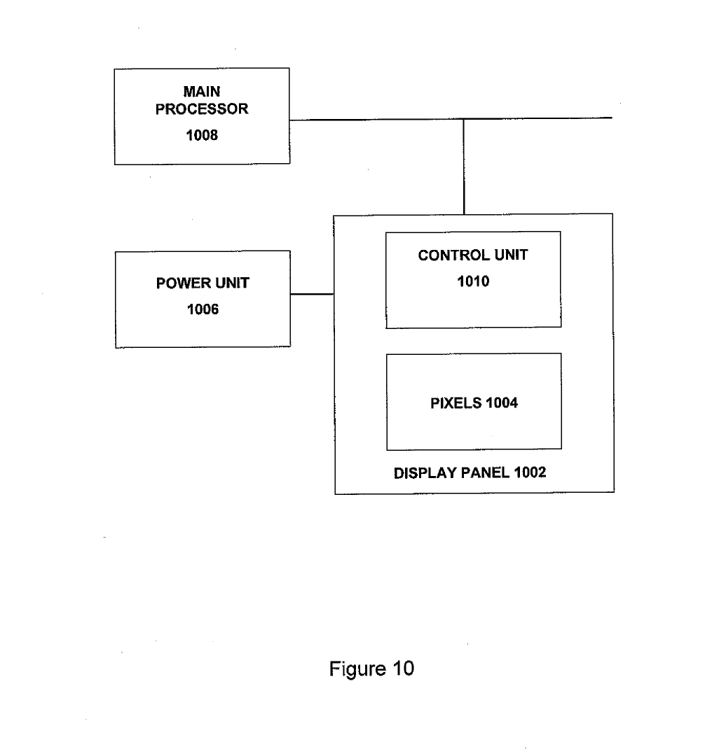

FIG. 10 shows a display panel system 1000 in accordance with one or more embodiments of the present invention. The display panel system 1000 includes a display panel 1002 having an irregular arrangement of pixels 1004, such as the display panel 300 in FIG. 3A. The pixels 1004 may include a plurality of LEDs such that light of any color may be emitted. The display panel system 1000 further includes a power unit 1006 configured to provide power to the pixels 1004 and electronics of the display panel 1002 and a main processor 1008 providing a data signal to at least one control unit 1010 of the display panel 1002. The display panel 1002 includes a power input, whereby the power unit 1006 is connected to the display panel 1002. The data signal may be any data signal known in the art, such as an analog video signal, a digital video signal, or still images.

The control unit 1010 is configured to control one or more pixels 1004 to emit a color of light based on the input data signal and the location of the one or more pixels 1004. Furthermore, the display panel 1002 may include a single control unit 1010 configured to provide a control signal to each pixel 1004 of the display panel 1002, or the display panel 1002 may contain more than one control unit 1010, wherein each control unit 1010 is configured to provide a control signal to a subset of pixels 1004. For example, in one embodiment each pixel 1004 may include a driver circuit, and the control unit 1010 may send a control signal to each driver circuit, whereby the driver circuit controls the intensity of each LED to produce a specified color. In another embodiment, each rib of the display panel may instead include a control unit 1010 configured to send a control signal to each driver circuit of the pixels 1004 on the rib.

Alternatively, the driver circuits of the pixels 1004 may constitute the control unit 1010. In such an embodiment, the data signal from the main processor 1008 may be sent to each driver circuit of each pixel 1004. A driver circuit for a pixel 1004 would then pull the respective data for the corresponding pixel from the data signal. Those skilled in the art will recognize that other configurations of a control unit 1010 and driver circuits may be used such that the pixels 1004 of the display panel 1002 are controlled to emit a color of light according to the data signal.

The signals between the main processor 1008, the control unit 1010, the driver circuits, and the pixels 1004 may be transmitted by any way known in the art, such as by cables, traces on a PCB, or wireless communication. For example, a cable from the main processor 1008 may connect to a signal input on the display panel 1002. Then, the control unit 1010, the driver circuits, and/or the pixels 1004 may be electrically connected to the input data signal by traces on a PCB. Alternatively, the main processor 1008, the driver circuits, and/or the pixels 1004 may receive the data signal from the main processor 1008 by wireless communication.

In controlling the pixels of typical display panels of the prior art (i.e., those having a regular arrangement), the pixels are usually addressed by the row and column location of each pixel. However, in embodiments of the present invention, a display panel has an irregular arrangement of pixels, and thus the pixels may not easily be addressed by the row and column locations. Accordingly, control of the pixels may require another method by which the pixels are controlled. Numerous methods already exist that may be utilized, and thus control of the irregular arrangement of pixels is within the skill of those in the art. In one embodiment, addresses may be mapped to the pixels prior to operation of the display panel. Alternatively, an over sampling or algorithmic processing could be utilized to break an input data signal into sub-pixels that closely match the irregular pattern of the pixels in the display panel. Also, software products have been developed that are able to address the control of irregular pixel arrangements, such as Rastermapper by Element Labs and Catalyst Media Server by High End Systems.

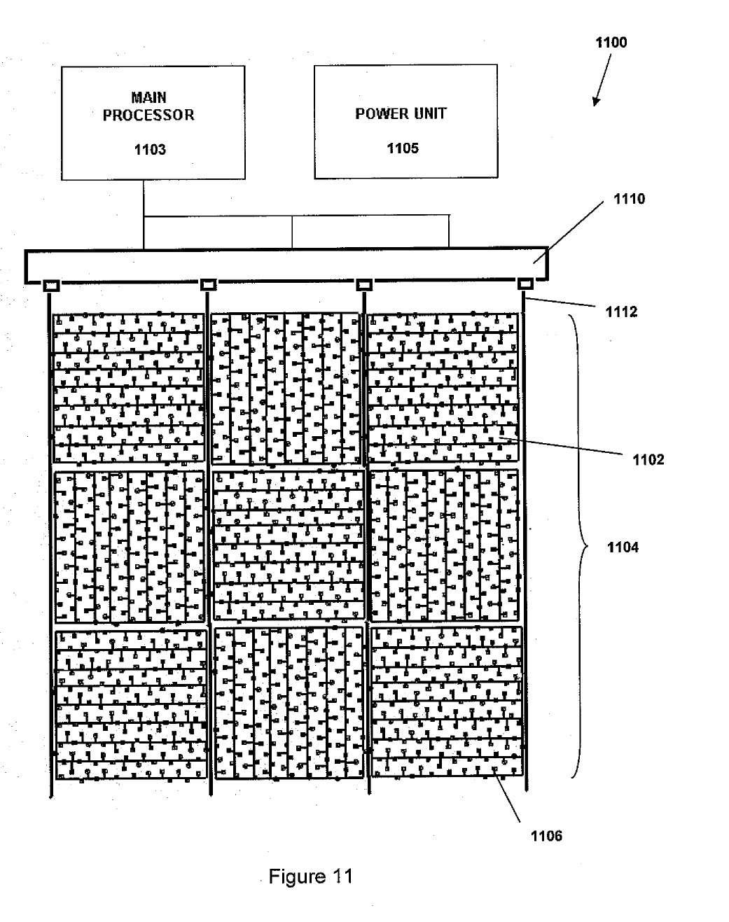

FIG. 11 shows a display system 1100 including a plurality of display panels 1102 in accordance with one or more embodiments of the present invention. The display panels 1102 are connected within the display system 1100 to form a display screen 1104. The display panels may be similar to any of the display panels previously discussed. Accordingly, the display panels 1102 have pixels 1106 arranged in an irregular arrangement. When combined in the display system 1100, the irregular arrangement of the pixels 1106 of each of the display panels 1102 forms an overall irregular arrangement of pixels 1106 in the display screen 1104. Thus, as has been previously discussed, the display system 1100 is configured to provide effective imagery while the display system 1100 is in use, and further minimizes the visual interference of the display system 1100 both when in operation and when turned off.

The display system 1100 may further include a main processor 1103 configured to provide data and/or control signals to the display panels 1102. Additionally, the display system 1100 may include one or more display panel systems, such as the display panel system 1000 of FIG. 10, and the main processor 1103 may be a part of such display panel systems. For example, each display panel 1102 may include a display panel system similar to display panel system 1000, and the main processor 1103 may provide a data signal to each of the display panel systems. Additionally, the main processor 1103 may collectively control all of the display panel systems such that an image is correctly and effectively displayed on the display screen 1104 according to a data signal. The display panel 1100 further includes one or more power units 1105 providing power for the display system 1100.

Any number, size, shape, and combination of display panels 1102 may be used to form the display screen 1104. Furthermore, the display screen 1104 may be of any size or shape. Additionally, the display panels 1102 may be connected within the display system 1100 by any method known in the art. Many display systems comprised of multiple panels exist in the art, and thus the construction of the display system 1100, and specifically the connection of the display panels 1102 therein, is well within the ability of those in the art.

In the embodiment of FIG. 11, for example, the display panels 1102 are suspended within a tensioned cable system. The tensioned cable system includes a suspending rod 1110 and cables 1112 suspended there from. The display panels 1102 are configured to connect to the cables 1112 such that they are suspended by the tensioned cable system to form the display screen 1104. In one embodiment, clips may be mounted on the outer edges of the frames of the display panels 1102. The display panels 1102 may then be attached to or disconnected from the cables 1112 through operation of the clips.

In another embodiment, the display panels 1102 may be configured to connect together to form the display screen 1104 without the use of a tensioned cable system. For example, connecting members may be mounted on the side, top, and/or bottom edges of the frames and/or ribs of the display panels 1102. Thus, each display panel 1102 may be configured to connect at any side to any other display panel 1102. In yet another embodiment, the display panels 1102 may be configured to connect to a series of studs that protrude from a building or other architectural structure to form the display panel 1104. Those skilled in the art will appreciate that this is only one example of a method by which a display screen may be formed on the exterior of a building or structure.

Additionally, the display panels 1102 may be connected together in more than one plane such that the display screen 1104 is not planar. Thus, the display screen 1104 may be formed in non-planar configurations or shapes, including arcs, c-shapes, zig-zag shapes, squares, etc. Furthermore, the display panels 1102 may be flexibly connected such that the display screen 1104 may be formed into any configuration or shape. Such a display screen may thus be formed to fit the surface of an irregularly shaped building or structure. Moreover, the display system 1100 may be used in other architectural capacities. For example, the display system 1100 may be used as a room divider, or the display system 1100 may be mounted on a roof or ceiling.

In yet another embodiment of the invention, the display panels 1102 may be arranged in multiple planes or layers to form a three-dimensional display. The display panels 1102 may overlap each other or be separated to form any configuration known in the art. In a display system having a three-dimensional array of display panels, a data image may be mapped to the different layers or display panels so as to form a three-dimensional image.

Embodiments of the present invention may provide one or more of the following advantages. Display units having an irregular arrangement of pixels may be architecturally more useful and aesthetically pleasing than typical display units having regular arrangements of pixels. Embodiments of the present invention may have irregular arrangements that have no discernible pattern, and thus do not produce negative moiré effects. Furthermore, irregular arrangements of pixels may be better able to conform to irregular surfaces. When mounted on buildings or structures, display units having an irregular arrangement of pixels may produce less interference with the design of the buildings and structures. Embodiments of the present invention may provide display panels that are also architecturally useful and aesthetically pleasing. For example, display panels may be transparent, and thus interfere less with structures on which they are mounted. Furthermore, such display panels may be easily constructed, and further formed into larger display units. Accordingly, embodiments of the present invention may provide effective imagery while in use, and further minimize visual interference both when in operation and when turned off.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A display panel, comprising:
a plurality of pixels disposed on a surface of the display panel,
wherein the plurality of pixels are configured to receive an electrical signal and power, and
wherein the plurality of pixels are disposed in an irregular arrangement.

2. The display panel of claim 1, further comprising:
a frame; and
a plurality of ribs connected to the frame,
wherein the plurality of pixels are disposed on the plurality of ribs.

3. The display panel of claim 1, wherein the irregular arrangement is based on a modified random sequence.

4. The display panel of claim 1, wherein the irregular arrangement is based on a dynamical low-discrepancy sequence.

5. The display panel of claim 2, wherein the plurality of ribs comprise at least one PCB, wherein the plurality of pixels are disposed upon and electrically connected to the at least one PCB.

6. The display panel of claim 5, further comprising:
a front cover; and
a back cover configured to connect to the front cover,
wherein the at least one PCB is disposed between the front cover and the back cover.

7. The display panel of claim 1, wherein the plurality of pixels each comprise at least one lighting element selected from the group consisting of: an LED, an OLED, a PLED, and an incandescent lamp.

8. The display panel of claim 1, wherein the plurality of pixels comprise a red LED, a green LED, and a blue LED.

9. The display panel of claim 8, wherein the plurality of pixels further comprise a driver circuit configured to vary the intensity of light emitted from the red LED, the green LED, and the blue LED.

10. The display panel of claim 1, wherein at least one of the plurality of pixels comprises a plurality of sub-pixels disposed in an irregular arrangement.

11. The display panel of claim 10, wherein at least one of the plurality of sub-pixels is formed in a first size, and at least another of the plurality of sub-pixels is formed in a second size.

12. The display panel of claim 1, further comprising a control unit configured to control the plurality of pixels to display an image.

13. The display panel of claim 1, further comprising a power input and a signal input.

14. A display panel, comprising:
a plurality of pixels disposed on a surface of the display panel, wherein the plurality of pixels are disposed in a regular arrangement and configured to receive an electrical signal and power; and
at least one light guide mounted over the plurality of pixels, wherein the light guide is configured to direct light emitted from the plurality of pixels into an irregular arrangement.

15. The display panel of claim 14, further comprising:
a frame; and
a plurality of ribs connected to the frame,
wherein the plurality of pixels are disposed on the plurality of ribs.

16. The display panel of claim 15, wherein the plurality of ribs comprise at least one PCB, wherein the plurality of pixels are disposed upon and electrically connected to the at least one PCB.

17. The display panel of claim 16, further comprising:
a front cover; and
a back cover configured to connect to the front cover,
wherein the at least one PCB is disposed between the front cover and the back cover.

18. A display system, comprising:
a plurality of display panels, wherein each of the plurality of display panels comprises:
a plurality of pixels disposed on a surface of the display panel,
wherein the plurality of pixels are configured to receive an electrical signal and power, and
wherein the plurality of pixels are disposed in an irregular arrangement,
wherein each of the plurality of display panels is mounted proximate to at least one other display panel.

19. The display system of claim 18, wherein each of the plurality of display panels further comprises:
a frame; and
a plurality of ribs connected to the frame,
wherein the plurality of pixels are disposed on the plurality of ribs.

20. The display system of claim 18, further comprising a tensioned cable system, wherein the plurality of display panels are connected to the tensioned cable system.

21. The display system of claim 18, wherein each of the plurality of display panels is configured to connect to at least one other display panel.

22. A method for displaying an image, comprising:
providing a display panel, wherein the display panel comprises:
a plurality of pixels disposed on a surface of the display panel,
wherein the plurality of pixels are configured to receive an electrical signal and power, and
wherein the plurality of pixels are disposed in an irregular arrangement; and
sending a data signal to the display panel, wherein the plurality of pixels are further configured to display the image based on the data signal.

23. The method of claim 22, further comprising:
sending the data signal to at least one control unit,
wherein the display panel further comprises the at least one control unit, and
wherein the at least one control unit is configured to send a control signal to the plurality of pixels based on the data signal.
